(19) United States
(12) Patent Application Publication
(10) Pub. No.: US 2022/0109733 A1
(43) Pub. Date: Apr. 7, 2022

(54) SERVICE MESH OFFLOAD TO NETWORK DEVICES

(71) Applicant: Intel Corporation, Santa Clara, CA (US)

(72) Inventors: Kefei ZHANG, Shanghai (CN); Fusheng ZHAO, Shanghai (CN); Yi ZENG, Shanghai (CN); Shihwei CHIEN, Zhubei (TW)

(21) Appl. No.: 17/550,883

(22) Filed: Dec. 14, 2021

(30) Foreign Application Priority Data
Nov. 19, 2021 (CN) PCTCN2021131685

(51) Int. Cl. H04L 67/51

(52) U.S. Cl. CPC H04L 67/16

(57) ABSTRACT

Examples described herein relate to a system for offloading microservice-to-microservice communication to a network interface device.

### CROSS-REFERENCE TO RELATED APPLICATION

This application claims the benefit of priority to Patent Cooperation Treaty (PCT) Application No. PCT/CN2021/131685 filed Nov. 19, 2021. The entire content of that application is incorporated by reference.

### DESCRIPTION

A service can be executed using a group of microservices executed on different servers. Microservices can communicate with other microservices using packets transmitted over a network. A service mesh is a infrastructure layer for facilitating service-to-service communications between microservices using application programming interfaces (APIs). A service mesh can be implemented using a proxy instance (e.g., sidecar) to manage service-to-service communications. Some network protocols used by microservice communications include Layer 7 protocols, such as Hypertext Transfer Protocol (HTTP), HTTP/2, remote procedure call (RPC), gRPC, Kafka, MongoDB wire protocol, and so forth. Envoy Proxy is a well-known data plane for a service mesh. Istio, AppMesh, and Open Service Mesh (OSM) are examples of control planes for a service mesh data plane.

### BRIEF DESCRIPTION OF THE DRAWINGS

FIG. 1 depicts an example system.

FIG. 2 depicts an example system.

FIGS. 3A-3C depict example configurations.

FIG. 3D depicts an example of data flow.

FIGS. 4-6 depict example operations.

FIG. 7 depicts an example process.

FIG. 8 depicts an example network interface device.

FIG. 9 depicts an example computing system.

### DETAILED DESCRIPTION

The sidecar communication model for microservices can introduce latency into service-to-service communications. Latency sensitive applications such as 5G control planes may not be able to tolerate the introduced latency. Some examples attempt to reduce latency of service-to-service communications by offloading communications for microservices into a network interface device while retaining performance of a microservice in a server or host. In some examples, the network interface device can execute a sidecar for a microservice to provide a proxy for service-to-service communications. The network interface device can schedule packet transmissions for a microservice to occur at particular time slots to reduce unexpected communication delay.

Some examples provide service mesh networking provisioned into an infrastructure processing unit (IPU) or data processing unit (DPU). As used herein, an IPU can refer to one or more of the following examples: a DPU, smartNIC, forwarding element, router, switch, network interface controller, network-attached appliance (e.g., storage, memory, accelerator, processors, security), and so forth. Different examples of an IPU can be used interchangeably so that reference to an example can refer to other examples alternatively.

A service mesh can be composed of the work nodes and IPUs. The work nodes can execute microservices, while the IPUs can provide inter and intra-service connections of a mesh. IPUs can serve multiple work nodes. A service mesh controller can provision IPUs to perform statics reporting or to update identification of devices that execute microservices.

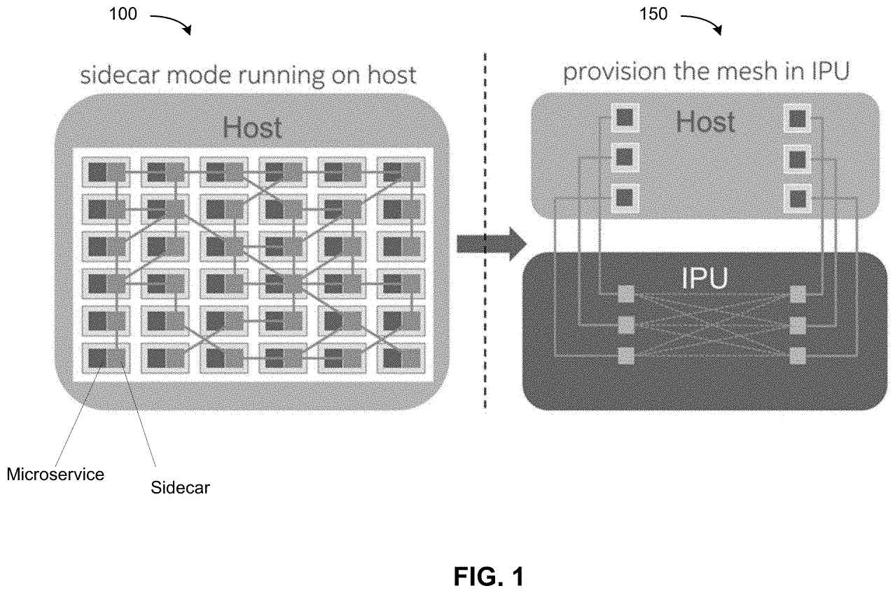

FIG. 1 depicts an example system. In configuration 100, a host executes an application (e.g., microservice) instance and its corresponding sidecar. A sidecar can perform networking for an application to communicate with other applications. A sidecar can manage network communications for an application. In this example, applications execute on a single host. However, Linux implementations of a sidecar such as eBPF may introduce latency of communication transmission as communication transmission may not occur at an expected time.

Configuration 150 provides for offloading service mesh sidecars to an IPU. A sidecar can perform one or more of: identification of a target microservice and routing and forwarding of traffic to a device that executes a target microservice. A sidecar can be executed in a container in some examples. In some examples, a sidecar can be consistent with Istio, Envoy, and so forth. Central processing unit (CPU) and memory utilization of a host can be reduced on a work node. In addition, an IPU can provide more predictable latency of service-to-service communications by controlling time of packet transmission on behalf of a microservice. For example, a microservice can make data available to a sidecar and the sidecar can determine a device that executes a service instance that data is to be sent to.

Various examples can utilize an orchestrator to deploy microservices for execution such as Kubernetes, Docker, OpenStack, Apache Mesos, and so forth.

Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

Various examples described herein can perform an application executed in a virtual machine. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

Various examples described herein can perform an application executed in a container. A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

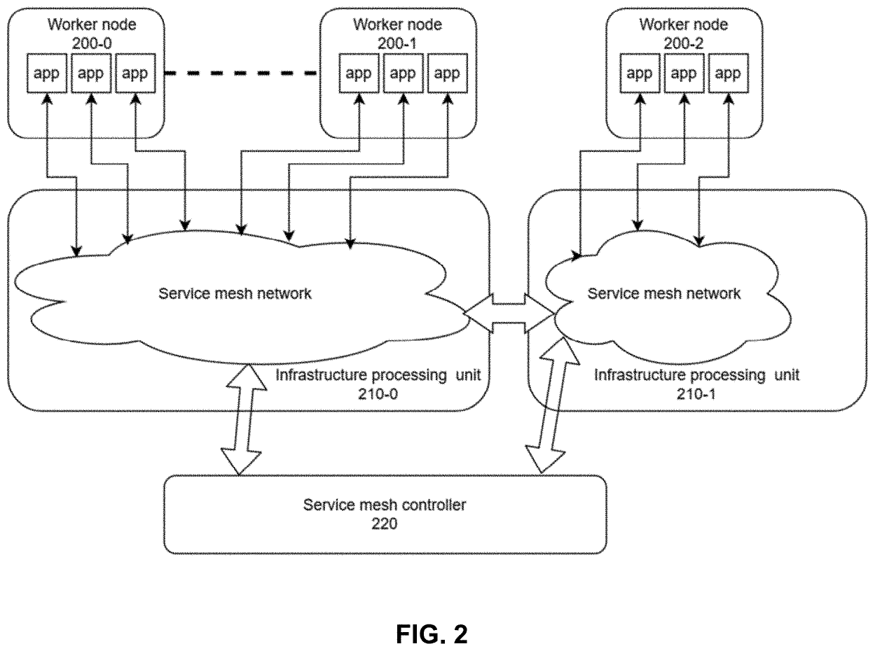

FIG. 2 depicts an example of a system. An IPU can support one or multiple hosts. A service mesh's side car can be delegated to an IPU so that worker nodes can offload managing communications in a network to the IPU. To run service mesh in an IPU, sidecar operations can be classified into control plane and data plane. A data plane can run in an IPU's system on chip (SoC) whereas a control plane can execute in the IPU's processor. A control plane can translate a network topology and routing decisions to hardware flow tables and dynamically update decisions to be performed by the data plane. The data plane can organize the service mesh network based on the flow tables from the control plane. The data plane can determine a next compute node or host that executes a target service and a network path or next network interface device to receive a communication. For packets that do not match a flow identified by the control plane, the data plane could request the control plane for a corresponding forwarding route and the control plane could generate a new forwarding rule and then inject the new forwarding rule for the packet's flow into the hardware for utilization. The data plane can be programmable or be a fixed function.

A packet in a flow can include a same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. In some examples, a flow can have its own time domain relative to main timer or other clock sources.

For example, IPU 210-0 can provide service mesh network connectivity using one or more sidecars for applications (e.g., microservices, VMs, or containers) executing on worker nodes 200-0 to 200-1. For example, IPU 210-1 can provide service mesh network connectivity using one or more sidecars for applications executing on worker node 200-2. Numbers of applications, worker nodes, and IPUs are illustrative and can be varied.

Service mesh controller 220 can configure IPUs 210-0 and 210-1 with identification of network addresses of hosts or nodes that execute microservices.

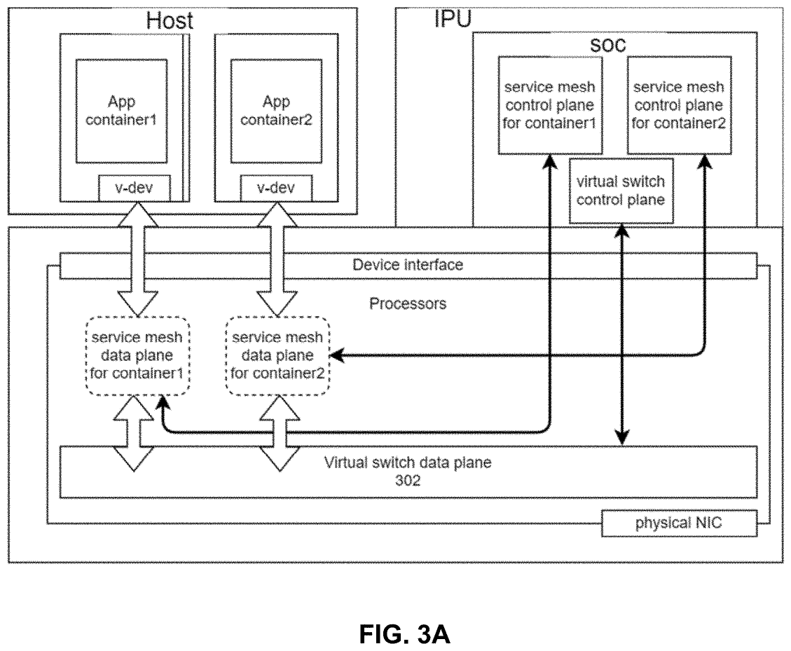

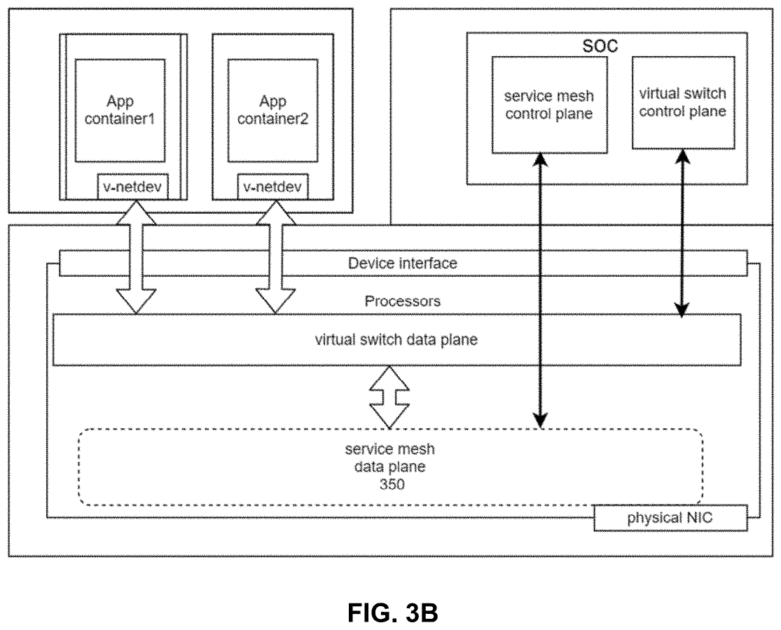

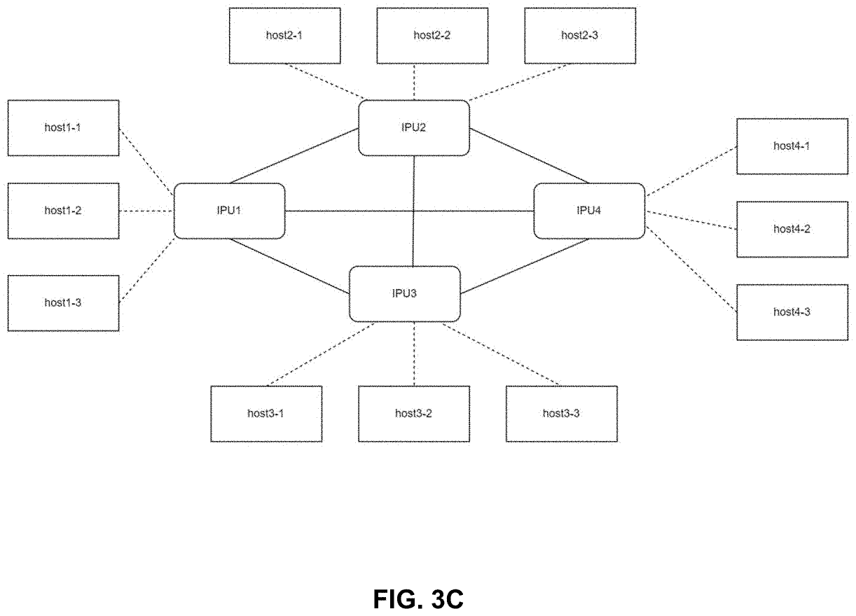

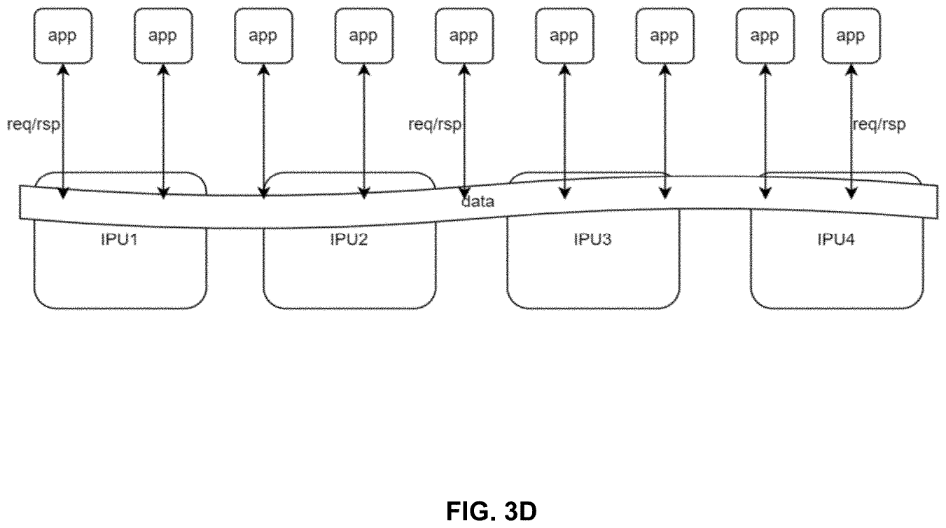

FIG. 3A depicts an example system. In this example, a service mesh sidecar is divided into control data and data plane. For data plane processing, IPU can process packets at layer 3 (L3) or layer 4 (L4) such as performing management of reliability protocols (e.g., Transmission Control Protocol (TCP) or User Datagram Protocol (UDP)), message delivery load balancing, or firewall (e.g., block forward progress of the packet). For control plane processing, the IPU can perform layer 7 (L7) processing in the SoC of the IPU such as HTTP communications. For example, control plane processing can include load balancing, routing decision to endpoint, egress port, rate limiting, telemetry. For example, control plane processing can program operation of the data plane.

The data plane can be executed in processors of the IPU and the control plane can be executed in a system on chip (SoC) of the IPU. IPU processors can include application specific integrated circuit (ASIC), field programmable gate array (FPGA), programmable match-action units, and so forth. Processors can be configured to perform match-action on received packets to identify packet processing rules and next hops using information stored in a ternary content-addressable memory (TCAM) tables or exact match tables in some examples. For example, match-action tables or match-action unit (MAU) circuitry can be used whereby a hash of a portion of a packet is used as an index to find an entry. Configuration of operation of packet processors can be programmed using one or more of: a configuration file, OneAPI, infrastructure programmer development kit (IPDK), NVIDIA® DOCA™ software development kit (SDK), Programming Protocol-independent Packet Processors (P4), C, Python, Broadcom Network Programming Language (NPL), or x86 compatible executable binaries or other executable binaries.

In some examples, control plane and data plane can communicate via a channel such a traffic class (TC) or Run Time Environment (RTE) channel. In some examples, virtual switch data plane 302 can provide a communication channel to transfer data between applications, control plane, and data plane. Virtual switch data plane 302 can setup a communication between service mesh data plane and control plane. The control plane can configure virtual switch data plane 302, directly or through the virtual switch control plane.

In some examples, a framework (e.g., IPDK or others) can be used to create virtual network devices (e.g., v-dev) executed in the host, and assign the virtual network devices to applications. Virtual network devices can be allocated hardware resources of the IPU's processors.

Data plane 302 can provide communications among virtual machines and SOC. Data plane 302 can provide communication among virtual network devices (v-dev) and data plane executing on the processors of the IPU. Data plane 302 can be implemented using Open vSwitch (OVS), in some examples.

Physical network interface controller (NIC) can provide communications with other devices over a network or fabric via one or more ports. NIC can be configured to use any one or more communication technology (e.g., wired or wireless communications) and associated protocols (e.g., Ethernet, InfiniBand®, Bluetooth®, Wi-Fi®, 4G LTE, 5G, etc.) to perform such communication. NIC can include one or more network hardware resources, such as ingress queues, egress queues, crossbars, shared memory switches, media access control (MAC), physical layer interface (PHY), Ethernet port logic, and other network hardware resources.

FIG. 3B depicts an example of applications utilizing an IPU in proxy mode. In this example, service mesh data plane 350 can interpret a packet and if a destination routing rule is available to service mesh data plane 350, route the packet to a next hop based on the destination routing rule. If a destination routing rule is not available to service mesh data plane 350, service mesh data plane 350 can cause the packet to be provided to a control plane for the sending container to determine a destination for the packet. The control plane for the sending container can configure service mesh data plane 350 with a destination routing rule for the packet such as a routing rule based on one or more packet header fields.

FIG. 3C depicts an example configuration. In this configuration, at least two of the hosts do not establish connection with another host. Instead, at least two of the hosts communicate with their associated IPU, in particular, the service mesh proxy. The IPUs perform service mesh communication.

FIG. 3D depicts an example of data flow. The application (e.g., microservice) can issue a get or send request to its associated IPU and receive a response from the IPU. For example, an application, executed by a host, can send the data to the IPU's service mesh agent, and allow the service mesh agent to determine the exact destination and routing to deliver the data. The IPU can insert an IP header for a packet with the data that is to be transmitted to another IPU and perform encryption (e.g., Transport Layer Security (TLS) encryption). For packet receipt, the IPU can process the received packet to extract the data and inform the destination application that data is available for access.

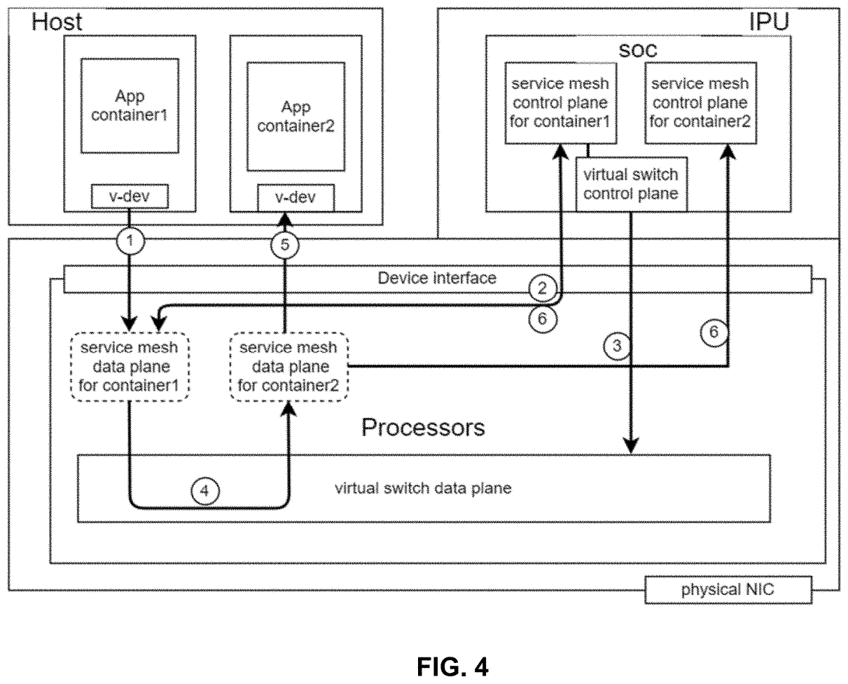

FIG. 4 is a data flow request from a container A to container B where both container A and container B execute on the same host. The request can be consistent with HTTP1.x/2, although other formats can be used. An example operation of the system of FIG. 4 is as follows. At (1), application container1 (e.g., microservice 1) can send data to service mesh data plane1, which executes in processors of the IPU. Service mesh data plane1 can interpret the packet to determine a destination. If service mesh data plane 1 is configured with a destination rule for the packet, the operation proceeds to (4). If service mesh data plane 1 is not configured with a destination rule for the packet, the operation can proceed to (2). At (2), service mesh data plane1 can cause the packet to be copied to control plane for container 1. Control plane for container 1 can analyze the packet, determine a destination for the packet, and provide the destination to service mesh data plane 1.

At (3), if service mesh control plane for container 1 determines a traffic control rule for the packet (e.g., destination device, communication duplicating, rate limiting, access control list), the rule could be translated by virtual switch control plane and sent to virtual switch data plane. At (4), the packet can be forwarded by virtual switch data plane to service mesh data plane for app container 2 (e.g., microservice 2). At (5), service mesh data plane for container 2 can copy the packet to a memory for access by app container2. At (6), service mesh data plane for container 1 and service mesh data plane for container 2 can send the metrics data to their control planes to indicate packet transmission volume to app container2 to indicate load or usage of app container2. Load information can be used to load balance instances of app container 2 to potentially avoid overuse of an instance of app container 2.

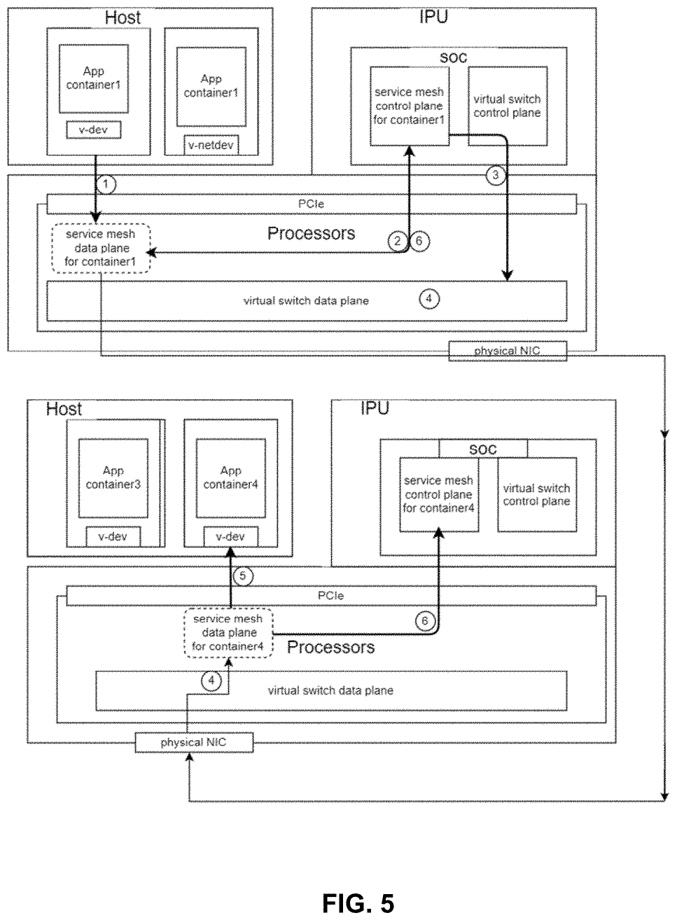

FIG. 5 is data flow example as a result of a request initiated from App container 1 to communicate with App container 4, where App container 1 and App container 4 are executed on different hosts. The request can be consistent with HTTP1.x/2, although other formats can be used. An example operation of the system of FIG. 5 is as follows. At (1), application container1 (e.g., microservice 1) can send data to service mesh data plane1. Service mesh data plane1 can interpret the packet to determine a destination for the packet. If service mesh data plane1 is configured with a destination rule, the operation proceeds to (4). If service mesh data plane1 is not configured with a destination rule, the operation can proceed to (2).

At (2), service mesh data plane1 can cause the packet to be copied to service mesh control plane for container1. Service mesh control plane for container1 can analyze the packet, determine a destination for the packet, and provide the destination to service mesh data plane for container 1. At (3), if service mesh control plane for container 1 determines a traffic control rule for the packet (e.g., destination, duplicating, rate limiting, access control list), the rule could be translated by virtual switch control plane and sent to virtual switch data plane. At (4), the packet can be forwarded by virtual switch data plane to service mesh data plane for app container 4 (e.g., microservice 4).

At (5), service mesh data plane for container 4 can copy the packet to app container4. At (6), service mesh data plane for container1 and service mesh data plane for container 4 can send metrics data to their respective control planes to indicate packet transmission volume to app container2 to indicate load or usage of app container2. Load information can be used to load balance instances of app container 2 to potentially avoid overuse of an instance of app container 2.

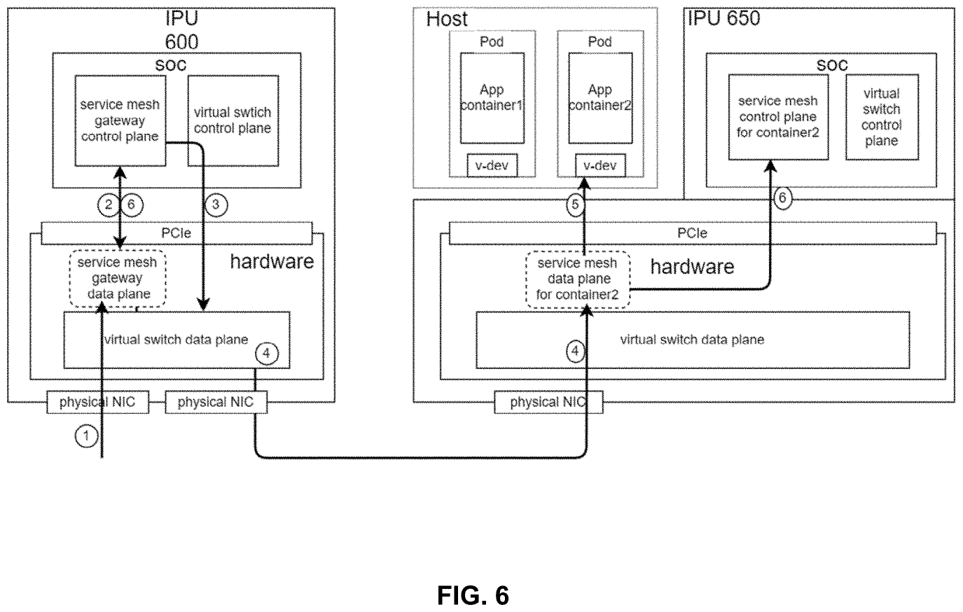

FIG. 6 is data flow of a proxy model. An example operation of the system of FIG. 5 is as follows. At (1), requests outside the service mesh are received at service mesh gateway, e.g., service mesh data plane of IPU 600. Service mesh gateway data plane can try to interpret the packet to determine a destination for the packet. If a destination rule exists, the operation proceeds to (4). If a destination rule does not exit, the operation can proceed to (2).

At (2), service mesh gateway data plane of IPU 600 can cause the packet to be copied to the gateway control plane. The gateway control plane can analyze the packet to determine a destination for the packet and provide a destination endpoint to the gateway data plane.

At (3), if gateway control plane determines a traffic control rule for the packet (e.g., destination, duplicating, rate limiting, access control list), the rule could be translated by virtual switch control plane and sent to virtual switch data plane of IPU 600. At (4), the packet can be forwarded by virtual switch data plane to service mesh data plane for container 2. At (5), service mesh data plane for container 2 can send the packet to App container2. At (6), service mesh gateway data plane for container 2 can send metrics data to control plane for container 2 to indicate packet transmission volume to app container2 to indicate load or usage of app container2. Load information can be used to load balance instances of app container 2 to potentially avoid overuse of an instance of app container 2.

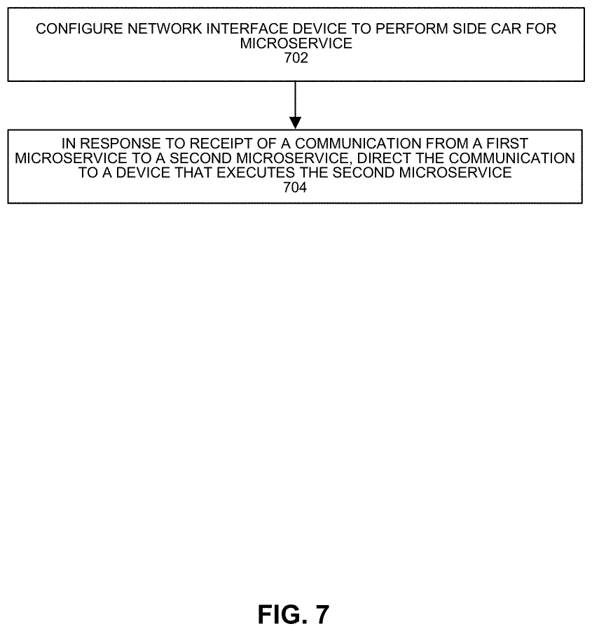

FIG. 7 depicts an example process. At 702, a network interface device can be configured to perform side car operations for a microservice executing on a host. Side car operations can include one or more of: identification of a target microservice, routing and forwarding of traffic to a device that executes a target microservice, communication duplicating, rate limiting, access control list, and so forth.

At 704, in response to receipt of a request from a first microservice to communicate with a second microservice, the network interface device can direct the communication to the second microservice executing on the same host that executes the first microservice or another host that executes the second microservice. The network interface device can utilize processors configured to perform a data plane to identify a destination device that executes the second microservice in order to transmit one or more packets to the destination device.

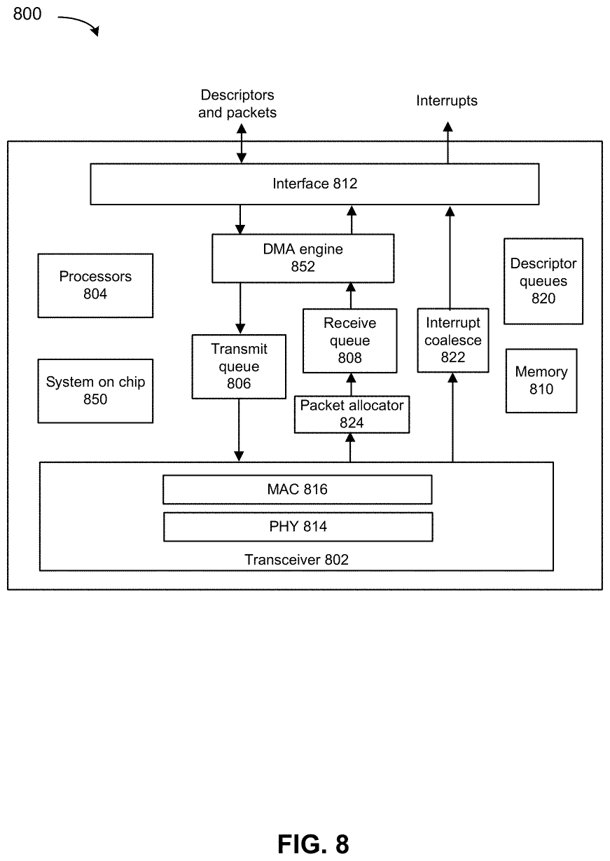

FIG. 8 depicts an example network interface device. The network interface device can include processors to perform control and data plane of a service mesh side car, as described herein. Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values.

Processors 804 can be any a combination of a: processor, core, graphics processing unit (GPU), field programmable gate array (FPGA), application specific integrated circuit (ASIC), or other programmable hardware device that allow programming of network interface 800. For example, a “smart network interface” can provide packet processing capabilities in the network interface using processors 804. Configuration of operation of processors 804, including its data plane, can be programmed using one or more of: configuration file, OneAPI, IPDK, NVIDIA® DOCA™ SDK, P4, C, Python, Broadcom NPL, or x86 compatible executable binaries or other executable binaries.

System on chip 850 can include microprocessors that execute instructions to perform a control plane for a service mesh side car, as described herein.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

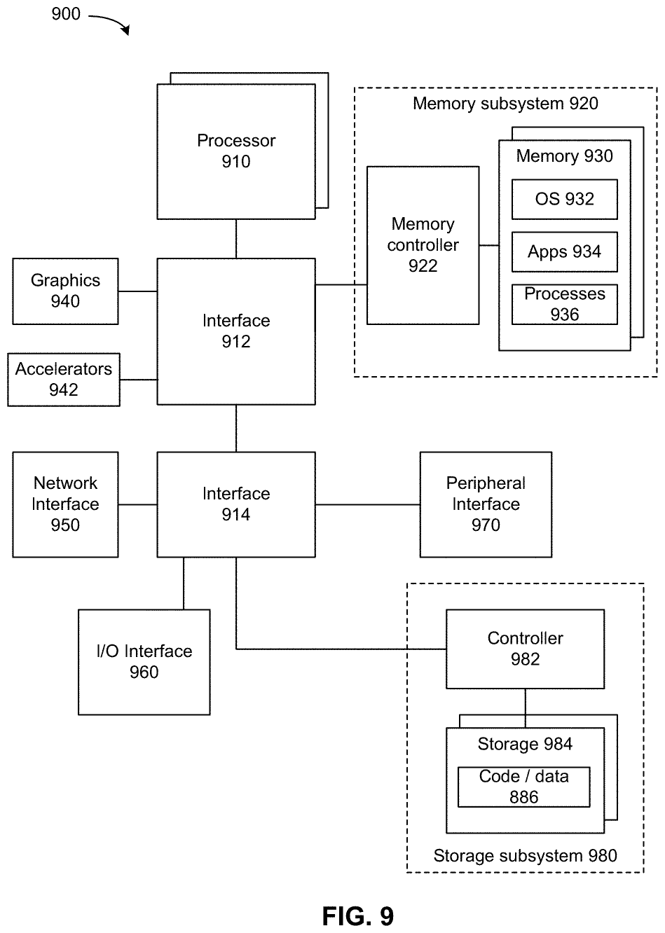

FIG. 9 depicts an example computing system. Components of system 900 (e.g., processor 910, network interface 950, and so forth) to perform microservices and sidecar communications, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure network interface 950 to perform side car operations, as described herein. In some examples, a driver can enable or disable offload to network interface 950 to perform side car operations, as described herein. A driver can advertise capability of network interface 950 to perform side car operations, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache.

A non-volatile memory (NVM) device is a memory whose state is determinate even if power is interrupted to the device. In one embodiment, the NVM device can comprise a block addressable memory device, such as NAND technologies. A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, edge servers, edge switches, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.′”

Illustrative examples of the devices, systems, and methods disclosed herein are provided below. An embodiment of the devices, systems, and methods may include one or more, and combination of, the examples described below.

Example 1 includes one or more examples, and includes a system comprising: a network interface device to manage communications for a microservice to one or more other microservices and manage communications to the microservice from the one or more other microservices, wherein management of communications for the microservice is offloaded to the network interface device from a host that executes the microservice.

Example 2 includes one or more examples, wherein the network interface device comprises one or more of: an infrastructure processing unit (IPU), data processing unit (DPU), smartNIC, network interface controller, or network-attached appliance.

Example 3 includes one or more examples, wherein to manage communications for a microservice to one or more other microservices and manage communications to the microservice from the one or more other microservices, the network interface device is to perform a control plane and a data plane for the communications.

Example 4 includes one or more examples, wherein the control plane is to configure the data plane to perform forwarding operations of a communication from the microservice to a destination microservice among the one or more other microservices.

Example 5 includes one or more examples, wherein the destination microservice is executed by the host that executes the microservice or executed by a different host.

Example 6 includes one or more examples, wherein the data plane is to perform one or more of: identification of a device that executes a destination microservice, communication duplication, rate limiting, or access control list.

Example 7 includes one or more examples, wherein the network interface device comprises a system on chip (SoC) and processor and wherein the SoC is to execute the control plane and the processor is to execute the data plane.

Example 8 includes one or more examples, wherein the processor comprises one or more of: application specific integrated circuit (ASIC), field programmable gate array (FPGA), or programmable match-action units.

Example 9 includes one or more examples, comprising the host that executes the microservice, wherein the host is communicatively coupled to the network interface device.

Example 10 includes one or more examples, comprising a datacenter that includes the host and a second host, wherein the network interface device is to provide the communication to the second host based on a destination microservice, among the one or more other microservices, executing on the second host.

Example 11 includes one or more examples, wherein management of communications for the microservice is offloaded to the network interface device from a host that executes the microservice comprises the microservice is to cause data to be copied to the network interface device and the network interface device is to generate at least one packet with the data and transmit the at least one packet to another network interface device associated with a target microservice, among the one or more other microservices.

Example 12 includes one or more examples, and includes a method comprising: at a network interface device, performing control plane and data plane operations for microservice communications to one or more processors.

Example 13 includes one or more examples, wherein: performing data plane operations for microservice communications comprises one or more of: identification of a device that executes a destination microservice, communication duplication, rate limiting, or access control list.

Example 14 includes one or more examples, wherein: performing control plane operations comprises configuring data plane operations for microservice communications.

Example 15 includes one or more examples, wherein the network interface device comprises a system on chip (SoC) and processor, the SoC performs the control plane operations, and the processor performs the data plane operations.

Example 16 includes one or more examples, wherein the network interface device comprises one or more of: an infrastructure processing unit (IPU), data processing unit (DPU), smartNIC, network interface controller, or network-attached appliance.

Example 17 includes one or more examples, and includes a non-transitory computer-readable medium comprising instructions, that if executed by one or more processors, cause the one or more processors to: configure a data processing unit (DPU) to perform inter-microservice communication on behalf of a microservice executing on a host.

Example 18 includes one or more examples, wherein the DPU comprises one or more of: an infrastructure processing unit (IPU), smartNIC, network interface controller, or network-attached appliance.

Example 19 includes one or more examples, wherein the inter-microservice communication comprises control plane and data plane operations, data plane operations comprise one or more of: identification of a device that executes a destination microservice, communication duplication, rate limiting, or access control list, and control plane operations configure data plane operations.

Example 20 includes one or more examples, wherein the DPU comprises a system on chip (SoC) and a processor, and comprising instructions, that if executed by one or more processors, cause the one or more processors to: configure the SoC to perform the control plane operations, and configure the processor to perform the data plane operations.

Example 21 includes one or more examples, comprising instructions, that if executed by one or more processors, cause the one or more processors to: configure the DPU to perform communication forwarding operations for a second microservice executed by a second host different than the host.

1. A system comprising:
a network interface device to manage communications for a microservice to one or more other microservices and manage communications to the microservice from the one or more other microservices, wherein management of communications for the microservice is offloaded to the network interface device from a host that executes the microservice.

2. The system of claim 1, wherein the network interface device comprises one or more of: an infrastructure processing unit (IPU), data processing unit (DPU), smartNIC, network interface controller, or network-attached appliance.

3. The system of claim 1, wherein to manage communications for a microservice to one or more other microservices and manage communications to the microservice from the one or more other microservices, the network interface device is to perform a control plane and a data plane for the communications.

4. The system of claim 3, wherein the control plane is to configure the data plane to perform forwarding operations of a communication from the microservice to a destination microservice among the one or more other microservices.

5. The system of claim 4, wherein the destination microservice is executed by the host that executes the microservice or executed by a different host.

6. The system of claim 3, wherein the data plane is to perform one or more of: identification of a device that executes a destination microservice, communication duplication, rate limiting, or access control list.

7. The system of claim 3, wherein the network interface device comprises a system on chip (SoC) and processor and wherein the SoC is to execute the control plane and the processor is to execute the data plane.

8. The system of claim 7, wherein the processor comprises one or more of: application specific integrated circuit (ASIC), field programmable gate array (FPGA), or programmable match-action units.

9. The system of claim 1, comprising the host that executes the microservice, wherein the host is communicatively coupled to the network interface device.

10. The system of claim 9, comprising a datacenter that includes the host and a second host, wherein the network interface device is to provide the communication to the second host based on a destination microservice, among the one or more other microservices, executing on the second host.

11. The system of claim 1, wherein management of communications for the microservice is offloaded to the network interface device from a host that executes the microservice comprises the microservice is to cause data to be copied to the network interface device and the network interface device is to generate at least one packet with the data and transmit the at least one packet to another network interface device associated with a target microservice, among the one or more other microservices.

12. A method comprising:
at a network interface device, performing control plane and data plane operations for microservice communications to one or more processors.

13. The method of claim 12, wherein:
performing data plane operations for microservice communications comprises one or more of: identification of a device that executes a destination microservice, communication duplication, rate limiting, or access control list.

14. The method of claim 12, wherein:
performing control plane operations comprises configuring data plane operations for microservice communications.

15. The method of claim 12, wherein
the network interface device comprises a system on chip (SoC) and processor,
the SoC performs the control plane operations, and
the processor performs the data plane operations.

16. The method of claim 12, wherein the network interface device comprises one or more of: an infrastructure processing unit (IPU), data processing unit (DPU), smartNIC, network interface controller, or network-attached appliance.

17. A non-transitory computer-readable medium comprising instructions, that if executed by one or more processors, cause the one or more processors to:
configure a data processing unit (DPU) to perform inter-microservice communication on behalf of a microservice executing on a host.

18. The computer-readable medium of claim 17, wherein the DPU comprises one or more of: an infrastructure processing unit (IPU), smartNIC, network interface controller, or network-attached appliance.

19. The computer-readable medium of claim 17, wherein
the inter-microservice communication comprises control plane and data plane operations,
data plane operations comprise one or more of: identification of a device that executes a destination microservice, communication duplication, rate limiting, or access control list, and
control plane operations configure data plane operations.

20. The computer-readable medium of claim 19, wherein the DPU comprises a system on chip (SoC) and a processor, and comprising instructions, that if executed by one or more processors, cause the one or more processors to:
configure the SoC to perform the control plane operations, and
configure the processor to perform the data plane operations.

21. The computer-readable medium of claim 17, comprising instructions, that if executed by one or more processors, cause the one or more processors to:
configure the DPU to perform communication forwarding operations for a second microservice executed by a second host different than the host.
